(19) United States
(12) Patent Application Publication
(10) Pub. No.: US 2019/0060773 A1
(43) Pub. Date: Feb. 28, 2019

(54) TOY VEHICLE RACETRACK WITH ABRUPT VEHICLE STOPPAGE

(71) Applicant: Anthony England, Chicago, IL (US)

(72) Inventor: Anthony England, Chicago, IL (US)

(21) Appl. No.: 15/686,586

(22) Filed: Aug. 25, 2017

(51) Int. Cl. A63H 18/16; A63H 18/02; A63H 18/06; A63H 17/14; A63H 29/22; A63H 30/04; A63H 18/08; A63F 9/14; A63F 13/803

(52) U.S. Cl. CPC A63H 18/16; A63H 18/023; A63H 18/026; A63H 18/06; A63F 13/803; A63H 29/22; A63H 30/04; A63H 18/08; A63F 9/143; A63H 17/14

(57) ABSTRACT

An electronic toy vehicle track that abruptly stops selected cars along their path of travel based of their progress on the course. The abrupt stoppage can occur as a result of a vehicles position relative to other vehicles on the track, time duration on the track, traveling at too low of a speed for any period of time or combinations of such data or other data. A selected car may abruptly stop by such methods as crashing into an obstacle having a disruption in its lane of travel by something such as a collapsing bridge.

### FIELD OF THE INVENTION

This invention applies to toy vehicle racetracks where the users provide real time input to operation of vehicles on a track. More specifically this invention applies to toy vehicle track arrangements where the progress of toy vehicle on the track is affected by changing the condition of the track path as a toy vehicle moves along the track.

### BACKGROUND OF THE INVENTION

Many toy vehicle racetracks provide tracks with variable and/or difficult paths of travel for the toy vehicle. Some such paths of travel will present conditions wherein traverse the difficult travel path by the toy vehicle is uncertain and may depend on the skill of the toy vehicle operator and/or chance. U.S. Pat. No. 5,102,133 issued Apr. 7, 1992 shows one example of one such arrangement wherein a toy vehicle track includes a vertical loop with a section of the track interrupted at an upper portion of the loop. U.S. Pat. No. 4,355,807 issued Oct. 25, 1982 shows another example of such an arrangement wherein a track includes a pivotable ramp that redirects the travel of the toy vehicle as it continues to traverse the track. Both arrangement examples show an operation that permits continuous travel of the toy vehicle along the track so long as the course diversion or the difficult travel path is successfully navigated.

Other such arrangements may bring the toy vehicle to a stop or slow the vehicle down directly or by diversion to a different path of travel. U.S. Pat. No. 5,174,569 shows a toy vehicle track with an engageable course diverter that can alter the path of travel of the toy vehicle to a longer or shorter path of travel. U.S. Pat. No. 6,109,186 issued Aug. 29, 2000 shows an interactive track that imposes course and/or speed changes to the cars depending on the history of the toy vehicle's movement around the track course. Again, both show an operation that permits continuous travel of the toy vehicle along the track to continue albeit after a slow down or a temporary stoppage.

### SUMMARY OF THE INVENTION

It is an object of the invention to provide additional elements of interest to toy vehicle race track arrangements.

It is a further object of this invention to provide a new approach to the interruption of a toy vehicle's travel along a race track.

It is a further object of this invention to provide a toy vehicle race track arrangement that disrupts all travel of a toy vehicle on the track in a dramatic manner.

This invention achieves these and other improvements by providing a new mode of operation to a toy vehicle racetrack arrangement.

Accordingly, this invention gives new suspense and excitement to such toy vehicle race tracks by causing vehicles to abruptly stop in a dramatic way that prevents any continued travel of the toy vehicle. In a preferred form of this toy track arrangement one or more toy vehicles abruptly and dramatically stop from any continued travel by crashing into objects. These crashes occur when at least one toy vehicle meets a preselected condition and/or randomly imposed condition. Conditions that can cause a toy vehicle to crash include the relative position of one vehicle with respect to another, a predetermined time of operation on the track, and/or a randomly determined time has lapsed. This invention may be applied to continuous race track or to single pass race tracks wherein vehicles travel from a starting end to a finishing end.

All reference in the following description of a vehicle or a car means a toy vehicle suitable for use on a toy vehicle racetrack arrangement.

Practice of the invention can arrange for any type of crash that abruptly stops the vehicle and prevents continued movement of the vehicle along the track. Non-limiting examples of suitable crashes include causing the vehicle to run into a blocking object (generally referred to herein as an abutment); dislocating a portion of the track along the vehicle's path of travel; and/or launching the vehicle from the track into the air.

Various arrangements can selectively crash a vehicle into an abutment. To abruptly stop a selected vehicle, an abutment may move from a position where it is clear of the vehicles along their normal path of travel and into a position that blocks any continued travel of the selected vehicle in a lane. Alternatively, or in addition, the course can include a crash lane into which a selected vehicle is directed to abruptly stop it. In this type of arrangement, the abrupt stop includes an abutment into which the car crashes or launching the vehicle into the air wherein the ground can serve as the abutment.

The abutment my take various forms. Non-limiting examples of such forms include common objects found along highways and raceways such as a wall, a tree, a fence, stacked hay bales etc. Generally, the abutment is made from a sufficiently soft material to prevent actual damage to the vehicle. Preferred materials are resilient foams and deformable foams with shape memory. The latter materials are particularly preferred so that impact by the vehicle will cause the vehicle to temporarily embed in the foam. The foam upon removal of the vehicle therefrom will regain its original shape. Another alternative can provide a variety of sound effects upon the car crashing into the abutment through from the abutment.

Another alternative for a more dramatic crash uses an abutment that gets deformed or destroyed by the impact of the car. In this case replacement abutments can be obtained or supplied for use and discarded after a crash. Such abutment can include non-toxic powders or materials that can pop or rupture to give the effect of smoke and/or sound upon impact by the vehicle.

A preferred crash causing arrangement removes a lane of travel by raising or dropping a stopping section of a lane. Thus, when the car reaches a raised stopping section it will fly above the track or upon encountering a dropped stopping section it will slam into a space below the track. Another non-limiting example of adding interest to the race track game will raise or drop the stopping section randomly or in response to the relative distance by which one vehicle trails another vehicle that is ahead of the trailing vehicle.

In a particularly preferred form, the dropping section of a lane takes the form of a bridge. The bridge may have a single dropping segment that bridges its span or it may have dual bridges or dropping segments that bridge its span are hinged from opposite sides of the bridge. Various enhancements to the bridge may increase interest in the crashes it causes. The vehicle may fall into a container located below the bridge. One non-limiting variation fills a pit below the bridge span with cushioning material that may emit a non-toxic powder or sound when impacted by the car. In another variation, where two dropping segments or bridges span the bridged distance, the dropping segment farthest from the approaching vehicle may engage a torsional spring when dropped that upon impact by the vehicle springs the vehicle backward.

The track arrangement may preempt control of the vehicles by a user to insure an interesting crash. To prevent a participant from slowing down or stopping their vehicle ahead of an impending crash, the system may take over control of the car upon its selection for a crash. Where the system uses wireless input to the vehicles, the system may control the velocity of a vehicle after its selection for a crash. In another variation, the track arrangement may take over the delivery of power to vehicles as they approach a section of track where a crash will occur. A simpler version may provide a minimum power input to any vehicle over a predetermined distance ahead of any crash area to maintain the velocity of all vehicles at the track location.

Chosen materials and designs for vehicle construction will maintain the integrity of the vehicles for most crash situations. However, it may be desirable to design the vehicle in a manner that all impacts or certain impacts cause portions of the vehicle to dislodge and/or fall off the vehicle. Such designs will preferably provide for simple reassembly of the vehicle to return to operation on the track when desired.

Various other devices or procedures, for example video games and challenge questions, can provide input for conditions that cause or adjust the timing or manner of the abrupt stop of a vehicle. For example, the track arrangement may incorporate the use of a video game that the users play separately or in competition. In one such arrangement, play of the video game establishes a lead time that one vehicle may need to maintain with respect to one or more other vehicles. Upon completing the video game stage of their race, participants would then operate their vehicles on the race. Results and/or input communicated from the video game to a controller can adjust the timing or triggering condition for abrupt stops of the vehicles on the track.

Accordingly, in a broad embodiment this invention is an electric model car racing system comprising a power supply and at least two lanes of travel along a track that provides a common course of travel for at least two cars with each lane providing an elongated path of travel for at least one electrically motorized toy car. The system includes a controller adapted to independently vary the speed of each car in response to one or more user inputs and at least one position sensor capable of detecting the position of at least one car. The system generates a stop signal by output from one or more position sensors when a car has a traveled for a predetermined or randomly determined distance or time. In response to the stop signal a lane stop physically blocks travel along at least one lane to prevent forward movement of at least one car in at least one lane. The lane stop usually includes an abutment into which at least one car is directed in response to the stop signal and into which the car makes impact to block its in at least one lane.

The system has at least one position sensor capable of detecting one or more lead cars and one or more trailing cars. A lead car is one that has traveled a greater distance than at least one other car. A trailing car is one that has traveled a lesser distance than at least one other car. A stop signal is generated by output from the position sensor in response to the position of one or more lead cars or trailing cars. Typically, the stop signal is generated when a lead car has a predetermined lead distance and the lead distance is the differential distance between at least one lead car and at least one trailing car. The sensor can be placed far enough ahead of the stopping section to allow the stopping section to come in to place before a trailing car reaches it. For example, where a bridge falls to create the stopping section to cause the abrupt stop of a trailing car, the sensor would be placed ahead of the bridge by a sufficient distance so that the appropriate bridge section will collapse before the trailing car reaches its respective bridge section. The sensor may be adapted to sense which car is leading and which car is trailing by the shortest differential distance possible by currently available sensor technology.

System control for the racing game can be accomplished using position sensors that are either mechanical or electronic. Mechanical position sensors detect a car using physical contact which triggers the stopping mechanism. Electronic position sensors detect a presence of a car using a digital means and an electronic processor sends a signal directing the stopping mechanism to activate.

In certain embodiments, a mechanical position sensor can detect a lead car by physical contact with the car. Such contact can cause the position sensor to generate the stop signal through a mechanical linkage that when triggered causes the lane stop to block travel along a lane.

In most cases the system will be a conventional slot car arrangement wherein a slot down the center of each lane will engage a pin or other engagement element located on the car. In the conventional cases, a pair of electrical conductors straddle each side of the slot to provide electrical power to each car in an amount regulated by the user through a remote control. In other embodiments, each car contains its own source of electrical power and the user, through a remote control, wirelessly regulates the speed of each car.

In other embodiments, the conditions causing generation of the stop signal may zo vary. In one arrangement, the lane stop is adapted for activation after the lead car has made at least two laps around the common course. In other arrangements, the stop signal is activated when the lead car has a predetermined lead distance with respect to at least one trailing car. In further embodiments a processor randomly determines, with or without input from the user, the value for at least one of the predetermined lead distance; a time measurement of the operation of one or more cars on the track; or an overall measurement of the distance traveled by at least one car that will cause generation of the stop signal to stop at least one car, at least two cars but less than all of the cars, or all of the cars.

In a more specific embodiment the invention is an electric model car racing system comprising a power supply and at least two lanes of travel along a track that provides a common course with each lane providing an elongated path of travel for at least one electrically motorized toy cars. A controller independently varies the speed of each car in response to one or more user inputs. At least one electronic position sensor detecting the position of at least one car without physical contact between the sensor and the car. An electronic processor communicates with the at least one position sensor that generates a stop signal. Generation of the stop signal may be based on a comparison of at least one of the predetermined lead distance wherein a lead distance comprises the differential distance between at least one lead car and at least one trailing car. In another embodiment, a time measurement of the operation of one or more cars on the track or an overall measurement of the distance traveled by at least one car on the track may cause generation of the stop signal. The processor may compare these measurements to a predetermined value input by a user or a randomly generated value to generate the stop signal. The stop signal causes a car to collide with a physical barrier placed in its path. The electronic processor, each position sensor and each car may be in wireless communication with each other.

In other embodiments, the processor communicates with a multi-light display that includes a start light to indicate when the cars may begin movement along the track and one or more warning lights that sequentially illuminate to prepare users that the start light is about to illuminate. In such embodiments the start sensor may detect any early starting user that starts a car down the track before the illumination of the start light and the electronic processor is capable of applying a penalty to an earlier user including adjusting of when the lane stop will prevent forward movement of that user's car.

### BRIEF DESCRIPTION OF THE DRAWINGS

FIG. 1 is a top view of a continuous two-lane slot car track with a bridge-type stopping mechanism and multi-light display that includes a start sensor, start light, and optionally one or more warning lights.

FIG. 2 is a top view of a discontinuous two-lane slot car track with a bridge-type stopping mechanism.

FIG. 3 is a side view of an open bridge-type stopping mechanism.

FIG. 4A and FIG. 4B are bottom views of a mechanically activated bridge in its raised position, rotating the lever as shown causes the bridge to fall.

FIG. 5 is a bottom view of an electrically activated bridge in its raised position.

FIG. 6 is a top view of two-lane slot car track with a diverter-type stopping mechanism.

FIG. 7 is a front view of a vertical light arrangement for providing a starting signal.

FIG. 8 is a flowchart showing system components and communication channels.

FIG. 9 is a flowchart showing system logic for an electronic processor (not mechanical) control system.

### DETAILED DESCRIPTION OF THE PREFERRED EMBODIMENTS

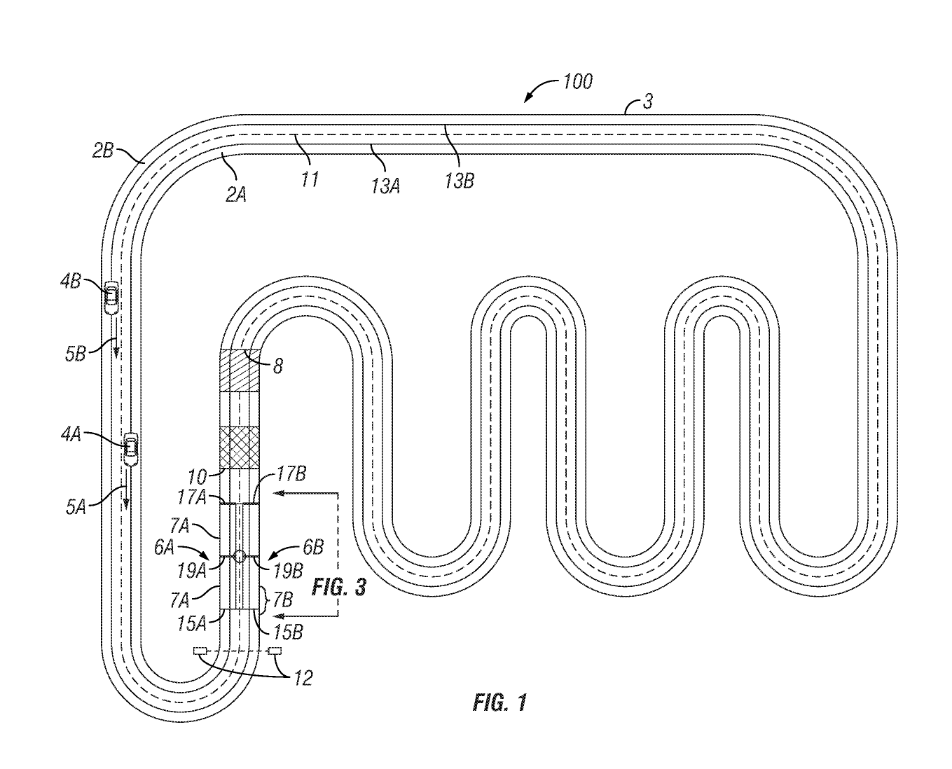

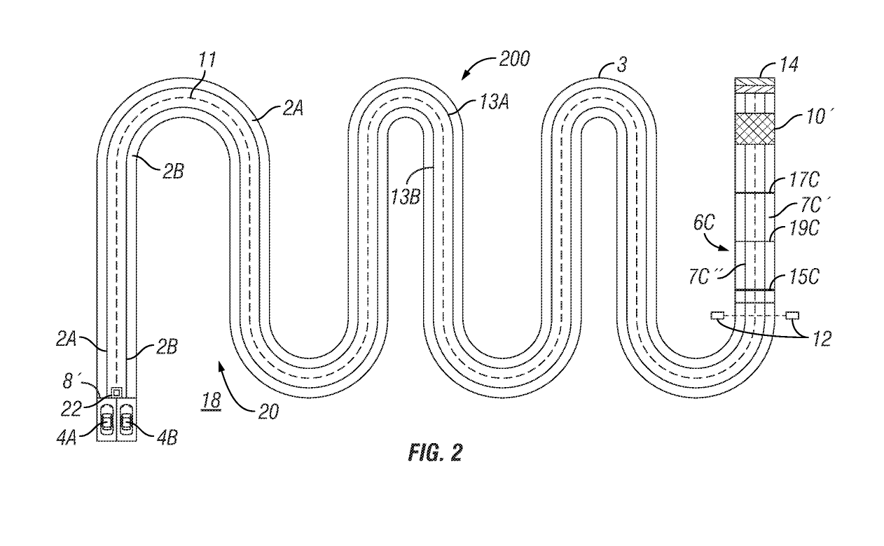

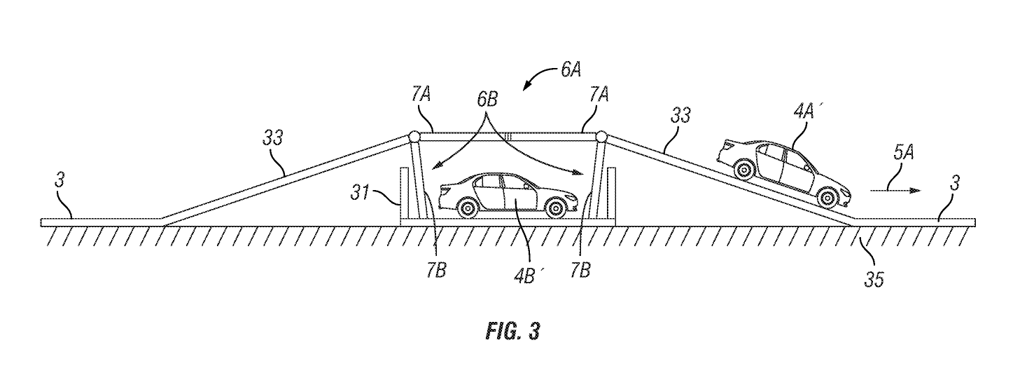

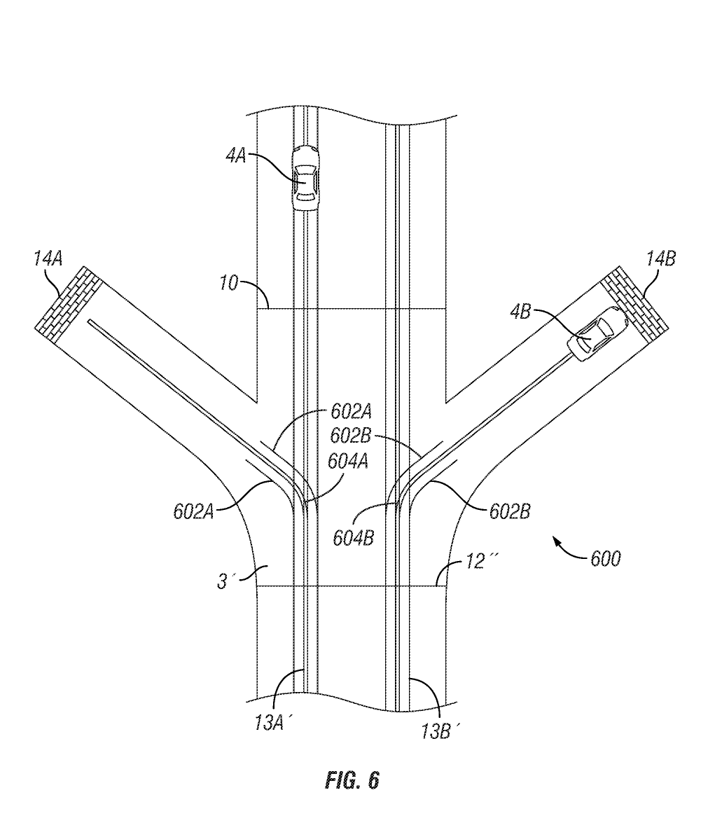

Referring to the drawings in detail, where like numbers reflect like elements, FIGS. 1 and 2 show preferred embodiments of a toy vehicle racing game with mechanisms that can stop the vehicles if certain conditions are met, and FIGS. 3-6, 8 and 9 show various embodiments of a preferred stop mechanism and system controls. FIG. 7 shows an optional starting light arrangement that in auto racing is often referred to as a “Christmas Tree.”

FIGS. 1 and 2 show embodiments of the toy vehicle racing game with a two-lane track. FIG. 1 shows a continuous track 100 that provides a continuous course of travel for the vehicles and FIG. 2 showing a discontinuous track 200 that provides a single pass of travel for the vehicles. A solid, elongate structure 3 composed of a single piece or multiple connected pieces provide the surface to Track 100 and Track 200. A centerline 7 that may or may not be shown on the structure 3 divides track 100 and track 200 into separate lanes of travel 2A and 2B for respectively guiding a car 4A and a car 4B. Centerline 7 shows the division between lanes 2A and 2B. Each lane of travel has a slot for guiding a vehicle. Each slot in a pair of parallel slots 13A and 13B guide a respective car 4A and 4B along its progress over the track. A pair of electrical conductors (not shown) may also straddle each of slots 2A and 2B to provide electrical power to cars 4A and 4B, respectively.

FIG. 1 and FIG. 2 show two separate course arrangements with different functionality. A user of the racing game may easily change from one track configuration to the other where the structure 3 is in discrete pieces. Additional pieces to structure 3 to Track 200 can convert to Track 100 by connecting its ends and taking pieces away from Track 100 can convert it to Track 200.

In playing the game with Track 200 the cars 4A and 4B travel along the length of track 200 beginning at a starting line 8′ and then racing to the finish line 10′. The first car that crosses the finish line 10 comes to a stop at or before a physical cushion 14. This cushion 14 is preferably made of a soft material such as foam, so that the first car to cross the finish line is not damaged upon contact and, as the winning car, preferably comes to a gentle stop.

The car that trails the first car is prevented from reaching the finish line by some form of physical abutment in any configuration that will interrupt forward progress of the trailing car before it reaches finish line 10′. A preferred feature of this invention will interrupt the car in a dramatic or interesting fashion.

Similarly in playing the game with the configuration of track 100, cars 4A and 4B may start racing from a start line 8. After traversing a predetermined or randomly determined number of laps around track 100 the race ends with the physical abutment stopping the travel of one car, typically the trailing car, and the other car continuing its progress and preferably crossing a finish line 10.

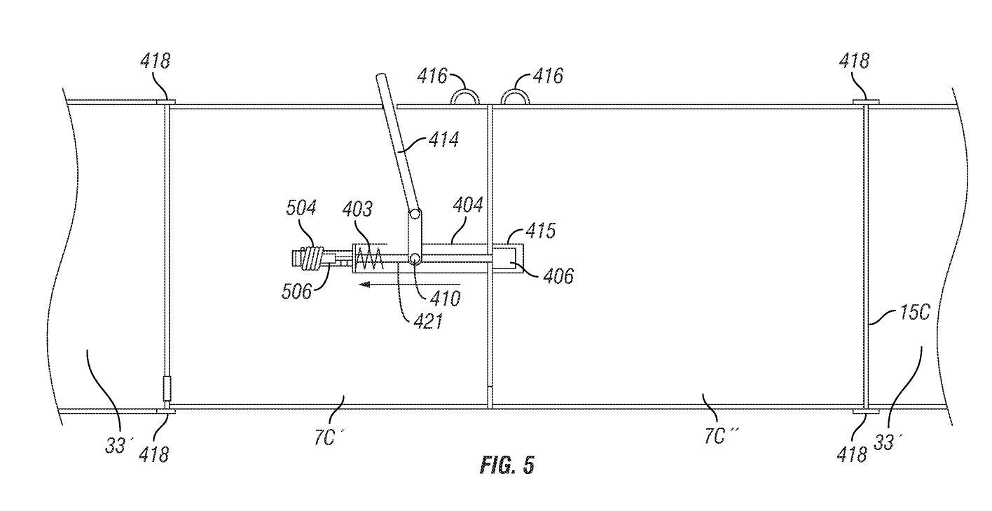

The toy cars can move along the track by any method of propulsion. In most cases an internal motor self-propels the cars by turning one or more of the wheels on the car. One option for powering the internal motor is the previously described conductors that are described as straddling each of slots 13A and 13B. FIG. 6 provides a view of a diverter section 600 that shows such conductors as numbers 602A straddling slot 13A to provide power to car 4A and 602B straddling slot 13B′ to provide power to car 4B. As also shown in FIG. 6, track structure 3′ retains the conductor at the surface of each lane 2A and 2B. A pair of conductors located on the cars and each resiliently biased against one conductor on the track supply the car with the electrical energy that activates the internal motor. Alternatively, the cars can contain an internal source of electrical energy from a battery or some other source of stored electrical power.

Each player can, at least in part, independently vary velocity of a car on the track. Typically, a player has a variable speed controller that increases or decreases the electrical power to a car's internal motor.

It is also possible to power the car with stationary contact wheels that temporarily contact the cars at discrete locations. In such an arrangement, a contact wheel embedded into the track provides a rotating contact surface that periodically contacts a car to give it forward acceleration and momentum. The car would then glide to the next wheel that again can propel it forward. Such contact wheels can also act in reverse to slow the car down and provide braking. Again, a player of the game will have at least some independent control of such drive wheels. In another embodiment, braking through contact wheels can provide an extra control feature to a setup with internally propelled cars.

Essential to the racing game is a stopping mechanism that directs one or more cars into a physical abutment or obstruction. This obstruction can be in the form of a reservoir the car falls into, a wall that the car is directed into, or some surface apart from the track into which the car is launched.

As a preferred embodiment, the tracks shown in FIGS. 1 and 2 contain a bridge-type stopping obstruction. Track 100 and track 200 each have a collapsing bridge segment 6A, 6B and 6C activated by a stop signal from a position sensor 12. When one or both cars pass the position sensor 12, a stop signal is generated that triggers the collapse of at least one lane in which a car is traveling. Each lane of the bridge may have the capability of collapsing separately, or both lanes of the bridge may collapse simultaneously.

The position sensor 12 can comprise any type of sensor or element that can provide an input to generate the stop signal. The stop signal may be electrical, mechanical, optical, wired or unwired. Generation of the stop signal will cause the abutment to block the path of at least one car.

FIG. 1 shows the abutment as bridges 6A and 6B having a lane segment 7A and a lane segment 7B each capable of collapsing independently from the other upon receiving a stop signal. Bridges 6A and 6B will collapse by separating about its respective joint 19A, 19B and rotating downward about its respective hinge section 17A, 17B and 15A, 15B. When a car encounters a collapsed bridge, it will drop below the bridge and hit an abutment in the form of a surface below the bridge.

FIG. 3 shows bridges 6A and 6B in side-view. Inclined sections 33 elevate the bridges 6A and 6B above the surface 35 upon which track structure 3 rests and provide a space below the track. FIG. 3 depicts bridge segments 7A in a connected position that allowed lead car 4A′ to pass over bridge 6A. Bridge segments 7B dropped into a collapsed state that causes the trailing car 4B′ to fall into the space below where bridge segments 7B were connected. The car 4B preferably falls into a container 31 located beneath the bridge. The container 31 may be lined with a soft material such as foam to protect the car when it falls.

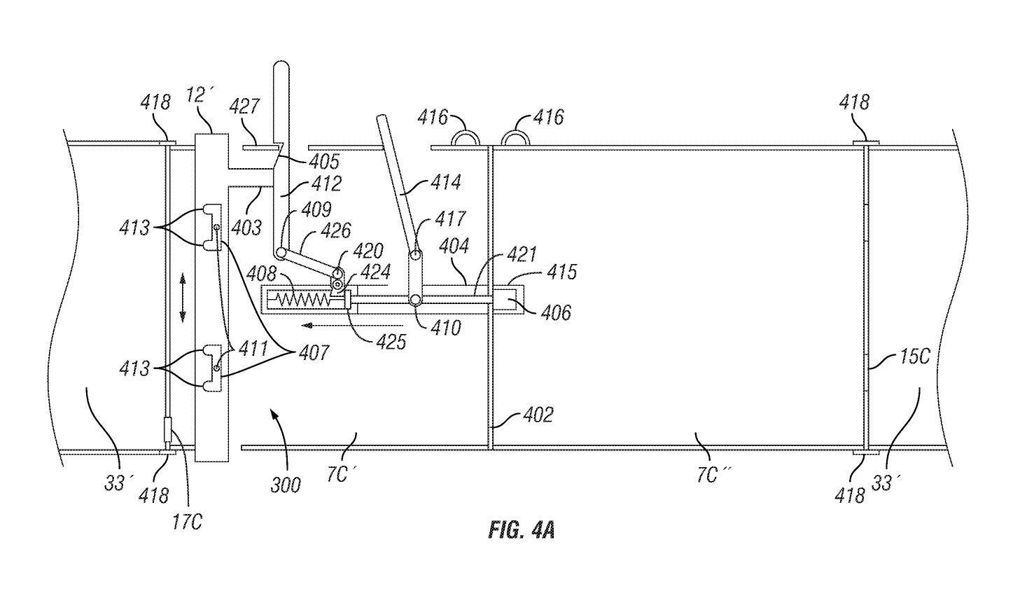

FIG. 2 shows a collapsing bridge 6C wherein lane segments 7C′and 7C″ make up two halves of the bridge. Each segment 7C′ and 7C″ having two lanes of travel. Bridge segments 7C′ and 7C″ separate about a joint 19C when bridge 6C collapses. FIG. 4 shows the underside of bridge 6c and a mechanism 300 that will cause segments 7C′ and 7C″ to fall and collapse bridge 6C. A tongue 406 extends from the segment 7C′ into a slot 407 defined by the bridge segment 7C″ and keeps the segments connected across joint 19C. Hinges 418 connect segments 7C′ and 7C″ to the track 3 and allow the track segments to swing from a connected position to a collapsed position where they fall open.

The mechanism of FIG. 4 has sleeve 404 fixed to the underside of segment 7C′ that retains a shaft 421 in a sliding arrangement to move tongue 405 from an engaged position, that keeps the bridge segments connected, to a retracted position as shown in FIG. 4B that causes the bridge segments to swing down and bridge 6C to collapse. A lock tab 424 holds an upset end 425 of shaft 421 against the tensile force of a spring 408 that exerts a disengagement force on tongue 406 through shaft 421. Pins 409 and 420 connect a release lever 412 to lock tab 424 through a link 426. A notch in release lever 405 holds the release lever in a locked position by resting on an edge 427 of segment 7C′.

A position sensor in the form of sensor strip 12′ has a tab 403 arranged to push against release lever 412 and cause disengagement of tongue 406 by rotation of lock tab 424 away from end 425 of shaft 421. FIG. 4A shows the sensor strip held in a neutral position by a pair of pins 411. Pins 411 extend through slots 407 that guide the movement of sensor strip 12′. When a lead car passes by the sensor strip it contacts an upwardly extending prong of the sensor strip (not shown) that extends above the track from one side of the sensor strip. This contact shifts strip 12 to one side and away from the lane in which the lead car was traveling, and in so doing aligns pins 411 with elongated ends 413 of slots 407. The contact also pulls another upwardly extended prong (not shown) of the sensor strip more directly into the lane of travel of the trailing car. When the trailing car contacts the upwardly extended prong the alignment of pins 411 with elongated end 413 of the slot allows the contact of the car to push the tab 403 against release lever 412 and dislodge notch 405 from edge 427. With release lever 412 now free to move the force of spring 408 pulls end 425 past lock tab 424 and removes tongue 406 from slot 415. As a result, the bridge 6C collapses before the trailing car reaches it and the trailing car falls below the bridge and preferably into a container such as that shown in FIG. 3.

Once the bridge has collapsed, it can be reset into the raised position by manually lifting the track segments using the attached rings 416 and then pulling the reset lever 414, which pivots on hinges 410 and 417 thereby elongating the spring 408 and sliding the tongue 406 back into slot 415, thereby suspending the two track segments. When the two track segments are properly suspended, notch 405 may be brought back to rest on edge 427, sensor strip 12′ is positioned with pins 411 in the center of slots 407 so that the track is complete again and cars can pass.

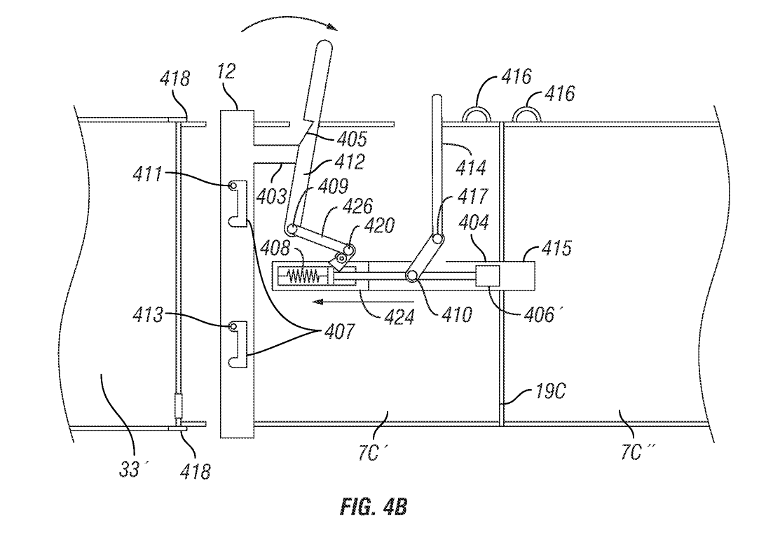

The bridge in figure FIG. 5 shows a similar underneath view of a two-sided bridge to that in FIG. 4, however, the control is accomplished through communication between an electronic position sensor (not shown) and a magnetically produced release. This position sensor is one that transmits data on car positions electronically. The data from the sensor produces a stop signal upon detecting a predetermined positioning of the car. The stop signal causes an electrical current to go through magnetic coil 504. In this arrangement shaft 421 has a metal plunger 506 on its end opposite tongue 406 and electrically charging of the coil 504 pulls the metal plunger into the coil thereby pulling tongue 406 out of slot 415 and again collapsing the bridge. The bridge may again be reset manually by using the reset lever 414 and the lifting rings 416 in the manner previously described and keeping the coil energized until the bridge segments are again brought together.

FIG. 6 shows a diversion-type alternate to the bridge-type collapsing methods of selectively stopping cars. In FIG. 6 there is a diverter section 600 for inclusion in two-lane track arrangement track which diverts the non-leading car 4B into a dead end and allows the leading car 4a to pass to the finish line 10. Electrical conductors 602A provide an electrical current to car 4A as it travels in slot 13A and electrical conductors 602B provide an electrical current to car 4B as it travels in slot 13B. The position sensor 12″ detects when the lead car 4A has passed. When the non-leading car 4B passes the position sensor 12 the lane switch 604B for the non-leading car's track redirects the car 4B to the branch portion 605B of the track. As displayed in FIG. 6, the electrical conductors 602b may not extend the full length of the branch. When the diverted car 4b passes the end of the conductors, there is no longer power being supplied to it to control the maximum speed of car 4B before it impacts abutment 14B.

The stop signal is generated upon conditions where the lead car has traveled further than at least one other car, where the lead car has a predetermined lead distance, or at a predetermined duration of the race. In a mechanical system, system options that control the stopping mechanism activation are predetermined. However, in an electrically controlled system, these options can be selected automatically by the electronic processor or manually by the user prior to the start of a race. User selections for these options can be made either through input on the track or on a remote controller.

The racing game can optionally include a light tree 22, as shown in FIG. 7, consisting of a start light 25, and optional warning or “ready” lights 25′ that illuminate in sequence to signal to the player(s) when to start the race. One or more sensors located at or near the start line 8 detect if a car passes beyond the start line 8 before the start light 18 is illuminated. In the case that a car passes the sensor before the start light 18 is illuminated the track electronic processor may penalize that player by adjusting their score or triggering the stopping mechanism sooner. The light tree may be plugged into a section of the track near the start line 8 that has a receptacle for receiving electrodes 29 that transmit the appropriate light sequence to the light tree 22.

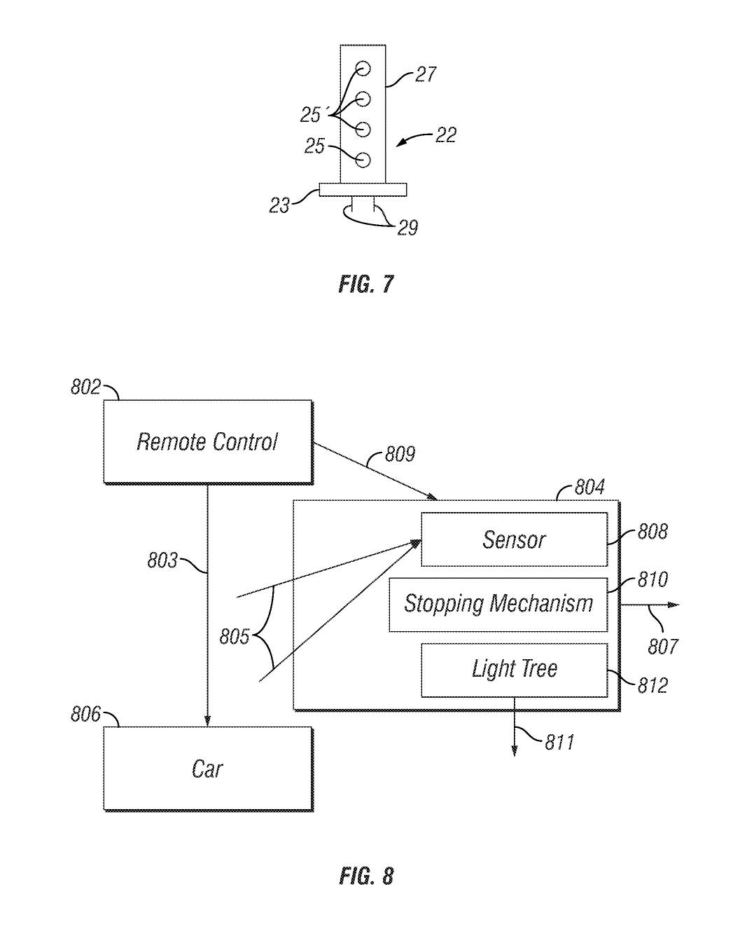

FIG. 8 shows a flow diagram for the electronic control of the bridge latch mechanism as shown in FIG. 5. Each player has a remote control 802 that communicates with the power source of their car 806 either via a hard wired or wireless communication path 803. (All communication and signals between remote control 802, car 806 and a microprocessor 804 may be hard wired or wireless.) A microprocessor 804 communicates with the remote control to know that the car is operating. The slot car game will have at least one additional remote control and car (not shown) for each player in the game that will typically communicate with a single microprocessor 804. As the cars move on the track one or more sensors on the track send a signal 805 to a sensor location 808 in the microprocessor 804 to record time data from the passage of each car in the microprocessor. The microprocessor 806 is programmed to generate a stopping signal 807 that activates a stopping mechanism control step 807 in the microprocessor 804. Signal 807 activates a bridge collapse mechanism of the type shown in FIG. 5. Input for varying the programming of microprocessor 804 may be supplied to the microprocessor via remote control 802 via communication link 809. The players may thereby alter the operation of the game by such input.

Microprocessor 804 may also contain a light tree control step 812. The light tree control step generates a signal 811 that illuminates the lights as desired. The microprocessor may also receive a signal via communication link 809 that indicates when a car has started moving ahead of the required start light and record or apply a penalty to the score of that player or to the operation or their car.

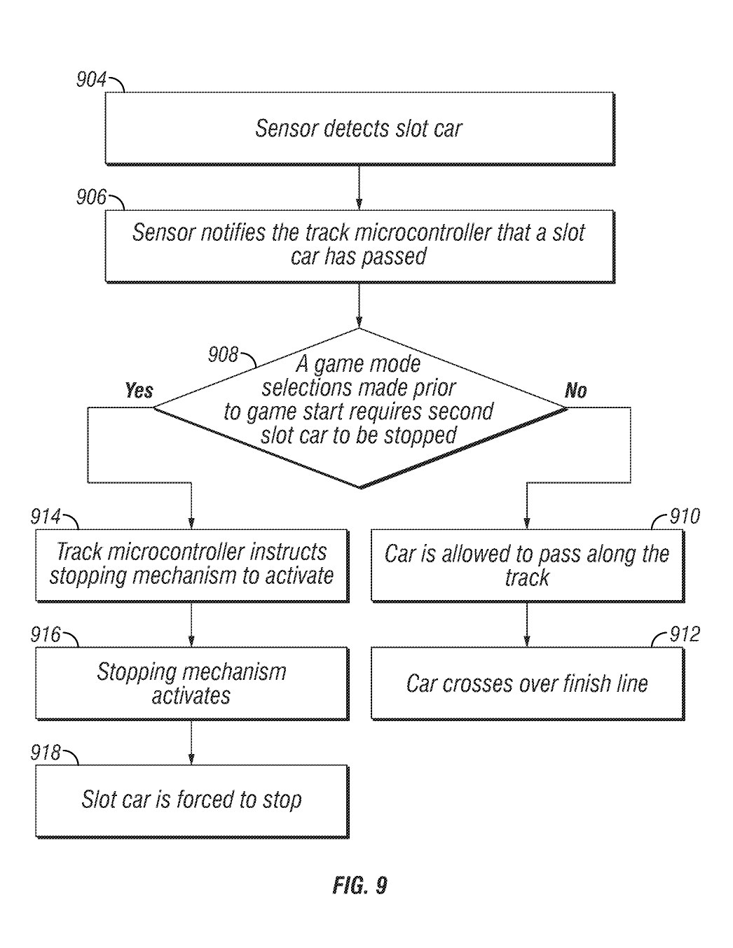

A more complete example of the physical elements for gathering data on the cars and of the logic within microprocessor 804 is shown in FIG. 9. (In this example elements of the track are not shown) Step 904 records that a slot car has crossed over a bar code scanner on the track that serves as an electronic position sensor. A bar code scanner scans the barcode that is imprinted or affixed on the underside of the slot car. In step 906 the bar code scanner notifies the track microcontroller. The microprocessor has been programmed at the start of the game to “timed race” mode and the microcontroller checks in step 908 whether the selected time limit has passed. If the microprocessor determines that it hasn't (No), then step 910 allows the car to pass and the car may pass to the finish line as indicated in step 912. If the time has passed (Yes), then the microprocessor in step 914 instructs bridge to collapse (such as by retract the tongue 406) such that the stopping mechanism activates as shown in step 916. This causes the bridge to open and the slot car falls into the container below the bridge.

Changes can be made in the above construction and operation of the game as described above and such variations are not to be limited other than as by the following claims.

1. An electric model car racing system comprising a power supply and at least two lanes of travel along a track that provides a common course of travel for at least two cars each lane providing an elongated path of travel for at least one electrically motorized toy car and a controller adapted to independently vary the speed of each car in response to one or more user inputs, said system further comprising:
at least one position sensor capable of detecting the position of at least one car;
a stop signal generated by output from one or more of said position sensors when said at least one car has traveled for a predetermined or randomly determined distance or time; and,
a lane stop that in response to the stop signal physically blocks travel along at least one lane to prevent forward movement of at least one car in said at least one lane.

2. The system of claim 1 wherein the lane stop includes an abutment into which at least one car is directed in response to the stop signal and into which the car makes impact to block its travel in at least one lane.

3. The system of claim 2 wherein lane stop comprises a falling portion of the track wherein a portion of at least one lane drops to open a space below the track into which at least one car is directed to fall in response to the stop signal and the structure below the track provides an abutment.

4. The system of claim 3 wherein the lane stop is in the form of a bridge assembly; two contiguous lane segments together provide a bridge lane over which a car may cross the bridge assembly when in a connected position; the lane segments are both adapted to drop into a lowered position in response to the stop signal; and any car directed across the bridge lane when the lanes segments are in a lowered position will fall beneath the bridge.

5. The system of claim 4 wherein; the track has two lanes, the bridge assembly comprises two parallel bridge segments that are arranged to collapse independent of each other, and each car travels in its respective lane; when one car is ahead of the other car, the car that is ahead passes over its respective bridge segments and continues until it passes over a finish line wherein each car has its own respective finish line; and after the car that is ahead passes over its respective bridge, its respective bridge opens and the car that is behind the other car fails to pass over its respective bridge and falls into a container below its respective bridge and each respective bridge has its own container.

6. The system of claim 4 wherein each lane segment has a lifting ring attached to its end that is proximate the other lane segment and can be pulled up to reconnect the bridge.

7. The system of claim 1 wherein the lane stop comprises a diverter arranged to divert at least one car out of a lane on the common course and into a lane stop comprising an abutment into which the at least one car is arranged to collide.

8. The system of claim 1 wherein the at least one position sensor is capable detecting one or more lead cars, wherein a lead car is one that has traveled a greater distance than at least one other car, and/or the at least one position sensor is capable of detecting one or more trailing cars, wherein a trailing car is one that has traveled a lesser distance than one other car and wherein the stop signal is generated by output from the position sensor in response to the position of one or more lead cars or trailing cars.

9. The system of claim 8 wherein the stop signal is generated when a lead car has a predetermined lead distance, said lead distance comprising the differential distance between at least one lead car and at least one trailing car.

10. The system of claim 8 wherein the position sensor comprises a mechanical detector that detects lead distance by physical contact with the at least one lead car and in response to such contact generates the stop signal through a mechanical linkage that when triggered causes the lane stop to block travel along said at least one lane.

11. The system of claim 8 wherein the position sensor comprises an electronic detector that collects a position input from at least one car without physically contacting said at least one car and the stop signal electronically activates the actuator for activating the lane stop in response to the position of at least one car.

12. The system of claim 11 wherein one or more position sensors detects the position of each car and each position sensor is in communication with an electronic processor that generates the stop signal based on at least one of the predetermined lead distance; a time measurement of the operation of one or more cars on the track; and an overall measurement of the distance traveled by at least one car on the track.

13. The system of claim 12 wherein the electronic processor, each position sensor and each car are in wireless communication with each other.

14. The system of claim 12 wherein the processor: is adapted to receive a predetermined number of laps for the users to complete and/or a predetermined time for the users to operate the system that will constitute the end of a race session; a clock and/or an alarm will signal the end of the race; and the processor activates a display that shows how many laps a player has won.

15. The system of claim 1 wherein the cars are guided along the track by a guide engaged with each car and a slot defined by the track for each lane of travel wherein the guide comprises a disengageable latch having a track slide arranged for travel through the slot and a latch retainer selectively engageable with and releasable from each car in response to a wireless release signal.

16. The system of claim 1 in which a pair of electrical conductors straddles each side of the slot to provide electrical power to each car in an amount regulated by the user through a remote control.

17. The system of claim 13 wherein each car contains its own source of electrical power and the user through a remote control wirelessly regulates the velocity of each car.

18. The system of claim 1 wherein the common course has a discontinuous path of travel with a start point at one end of the path of travel and a finish point at the opposite end of the path of travel; the lane stop is located between the start point and end point; the position sensor is located between the start point and end point and the lane stop is arranged for activation each time more than one car travels down the common course.

20. The system of claim 13 wherein the processor randomly determines, with or without input from the user, the value for at least one of the predetermined lead distance; a time measurement of the operation of one or more cars on the track; or an overall measurement of the distance traveled by at least one car that will cause generation of the stop signal; and the stop signal stops at least one car, at least two cars but less than all of the cars, or all of the cars.

21. The system of claim 1 wherein the system includes a multi-light display that includes a start light to indicate when the users of the system may begin movement down or their cars down the track and the multi-light display optionally includes one or more warning lights that illuminate to prepare users that the start light is about to illuminate.

22. An electric model car racing system comprising a power supply and at least two lanes of travel along a track that provides a common course with each lane providing an elongated path of travel for at least one electrically motorized toy cars and a controller adapted to independently vary the speed of each car in response to one or more user inputs, said system further comprising:
at least one electronic position sensor capable of detecting the position of at least one car without physical contact between the sensor and the car;
an electronic processor in communication with the at least one position sensor that generates a stop signal based on a comparison of at least one of the predetermined lead distance wherein a lead distance comprises the differential distance between at least one lead car and at least one trailing car; of a time measurement of the operation of one or more cars on the track and of an overall measurement of the distance traveled by at least one car on the track wherein the comparison is with a predetermined value input by a user or a randomly determined value generated by the processor; and,
a physical barrier into which at least one car will collide in response to the stop signal to physically block said one car from forward movement in at least one lane.

23. The system of claim 22 wherein the electronic processor, each position sensor and each car are in wireless communication with each other; each car contains its own source of electrical power; the physical barrier stops at least one car, at least two cars but less than all of the cars, or all of the cars; the processor communicates with a multi-light display that includes a start light to indicate when the cars may begin movement along the track and one or more warning lights that sequentially illuminate to prepare users that the start light is about to illuminate; and a start sensor detects any early starting user that starts a car down the track before the illumination of the start light and the electronic processor is capable of applying a penalty to an earlier user including adjusting of when the lane stop will prevent forward movement of that user's car.

24. An electric model car racing system comprising a power supply and at least two lanes of travel along a track that provides a common course each lane providing an elongated path of travel for at least two electrically motorized toy cars and a controller adapted to independently vary the velocity of each car in response to one or more user inputs, said system further comprising:
at least one electronic position sensor capable of detecting the position of at least one car without physical contact between the sensor and the car;
a bridge section arranged on the path of travel of the cars on the track having an electronically activatable release that will cause the bridge for at least one lane of travel to drop and physically block any forward travel of any car in said lane of travel; and an electronic processor in communication with the at least one position sensor that activates the release based on a comparison of at least one of a predetermined lead distance wherein a lead distance comprises the differential distance between at least one lead car and at least one other car; a time measurement of the operation of one or more cars on the track; and an overall measurement of the distance traveled by at least one car on the track wherein the comparison is with a predetermined value input by a user or randomly determined value generated by the processor.
